(19) United States
(12) Patent Application Publication
(10) Pub. No.: US 2015/0103529 A1
(43) Pub. Date: Apr. 16, 2015

(54) METHODS OF FORMING REFLECTIVE COATINGS AND LIGHTING SYSTEMS PROVIDED THEREWITH

(71) Applicant: GE LIGHTING SOLUTIONS, LLC, East Cleveland, OH (US)

(72) Inventors: Dengke CAI, Mayfield Heights, OH (US); Gary Robert ALLEN, Chesterland, OH (US); Matthew A. BUGENSKE, Cleveland Heights, OH (US); Martin Norman HASSINK, Warren, OH (US); Cherian JACOB, Brecksville, OH (US); Christopher Henry WILSON, Lachine (CA)

(21) Appl. No.: 14/572,922

(22) Filed: Dec. 17, 2014

Related U.S. Application Data
(63) Continuation-in-part of application No. 13/711,991, filed on Dec. 12, 2012.
(60) Provisional application No. 61/635,463, filed on Apr. 19, 2012.

(51) Int. Cl. F21V 7/22; F21V 7/10

(52) U.S. Cl. CPC F21V 7/22; F21V 7/10; F21Y 2103/00
USPC 362/296.02; 427/162

(57) ABSTRACT

Methods and materials capable of controlling the type and relative amounts of reflectance (e.g., specular vs. diffusive reflection) in reflective coatings, especially for inclusion in a lighting fixture or other lighting source. A method of forming a reflective coating on a substrate includes applying to the substrate a precursor material that comprises a cross-linkable binder resin, a cross-linking agent, and scattering pigment particles. The pigment particles are predominantly at or near an outer surface of the applied precursor material. Thereafter, the applied precursor material undergoes a single or multistep cure to form the reflective coating by cross-linking the binder resin. The cure energy level and duration inhibit migration of the pigment particles and/or the binder resin in the applied precursor material so that the pigment particles remain predominantly at or near an outer surface of the reflective coating.

### CROSS REFERENCE TO RELATED APPLICATIONS

This is a continuation-in-part patent application of co-pending U.S. patent application Ser. No. 13/711,991, filed Dec. 12, 2012, which claims priority to U.S. Provisional Patent Application Ser. No. 61/635,463, filed Apr. 19, 2012. The contents of these prior applications are incorporated herein by reference.

### BACKGROUND OF THE INVENTION

Embodiments of the present invention generally involve reflective coatings for inclusion in lighting devices. More particularly, certain embodiments relate to methods of forming a reflective coating for inclusion in a lighting device.

Reflective coatings or films have been used to selectively reflect or transmit light radiation from various portions of the electromagnetic radiation spectrum, such as ultraviolet, visible, and/or infrared radiation. For instance, reflective coatings are commonly used in the lamp industry to coat reflectors and lamp envelopes. One application in which reflective coatings are useful is to improve the illumination efficiency, or efficacy, of lamps by reflecting infrared energy emitted by a filament, or arc, toward the filament or arc while transmitting visible light of the electromagnetic spectrum emitted by the light source. This decreases the amount of electrical energy necessary for the light source to maintain its operating temperature. Another application of reflective coatings is to improve the efficacy of luminaires by reflecting the visible light from the lamp from a high-reflectance coating on the surface of the luminaire to redirect the light into the intended application space.

In addition to the reflectivity (R %) of the reflective coating, the coating can also be described in terms of angular distribution of reflectance, known as the bi-directional reflectance distribution function (BRDF) In general, BRDFs may be characterized as specular (mirror-like) and diffuse. A perfectly specular reflector obeys Snell's Law whereby all light rays exit from the surface at a reflection angle, θ, relative to the normal that is same as the incident angle, θ, if the surface is embedded in air, having index of refraction=1. A perfectly diffuse reflector has a Lambertian BRDF whereby the distribution of reflected light varies as cos(θ), independent of the incident angle. Practical reflectors are neither perfectly specular, nor perfectly diffuse. Any practical specular reflector will have a small component of diffuse reflectance, generally known as scatter or haze. Any practical diffuse reflector will have a small specular component of reflection. A reflector having a relatively high specular component is generally known as glossy, while a reflector having a near zero specular component is generally known as matte or flat. In specular reflection, the angle of the light reflected from the surface is equal and opposite to the angle of the incident light. A diffuse reflector scatters the incident light over a range of directions. While the amount of overall reflectance of a coating can be controlled through its components, the control of the BRDF also depends on the surface morphology (roughness).

A continuing need exists for methods and materials capable of controlling the type and relative amounts of reflectance (e.g., specular vs. diffusive reflection) in reflective coatings, especially for inclusion in a lamp or other lighting device.

### BRIEF DESCRIPTION OF THE INVENTION

Aspects and advantages of the invention are set forth below in the following description, or may be obvious from the description, or may be learned through practice of the invention.

According to one aspect of the invention, a method of forming a reflective coating on a substrate includes applying to the substrate a precursor material that comprises a cross-linkable binder resin, a cross-linking agent, and scattering pigment particles. At least some of the pigment particles are at or near an outer surface of the applied precursor material. Thereafter, the applied precursor material undergoes curing to form the reflective coating by cross-linking the cross-linkable binder resin to form a cured binder and optionally a partially-cured binder resin. The curing process comprises at least one of a soft-cure step and a hard-cure step, and sufficiently inhibits softening and migration of the cross-linkable binder resin, the cured binder, and any of the optional partially-cured binder resin so that a sufficient amount of the pigment particles that were at or near the outer surface of the applied precursor material protrude through or remain exposed at an outer surface of the reflective coating to achieve a matte finish at the outer surface.

Other aspects of the invention include a lighting apparatus that includes a reflective coating produced by a process comprising the steps described above. A particular but nonlimiting example is a lighting apparatus comprising a light source, the reflective coating formed on the substrate and positioned to reflect light emitted by the light source, and optionally a primer coating between the reflective coating and the substrate.

The cross-linkable binder resin can, in certain embodiments, comprise or entirely be a polymeric powder.

Those of ordinary skill in the art will better appreciate the features and aspects of such embodiments, and others, upon review of the specification.

### BRIEF DESCRIPTION OF THE DRAWINGS

FIG. 1 shows a schematic cross-sectional view of a reflective coating on a substrate.

FIG. 2 shows a schematic cross-sectional view of an exemplary lamp that includes a reflective coating.

FIG. 3 shows another exemplary lighting system that includes a conformable reflector positioned between a lamp and a fixture housing installed in a conventional fluorescent lighting fixture.

FIG. 4 shows one embodiment of the lighting system of FIG. 3, with the reflector attached to the glass tube by a stripe of adhesive.

FIG. 5 shows another exemplary lighting system that utilizes a collar of flexible material surrounding the lamp.

FIG. 6 shows another exemplary lighting system that includes a reflector positioned between a lamp and fixture housing, and FIG. 7 shows an isolated view of the reflector of FIG. 6.

FIG. 8 shows a reflectance spectrum of an exemplary reflective coating.

FIGS. 9, 10, 11 and 12 show reflective coatings that were formed under different curing processes that included a hard-cure step and, in some cases, a soft-cure step that preceded the hard-cure step.

### DETAILED DESCRIPTION OF THE INVENTION

Reference will now be made in detail to present embodiments of the invention, one or more examples of which are illustrated in the accompanying drawings. This detailed description uses numerical and letter designations to refer to features in the drawings. Like or similar designations in the drawings and description have been used to refer to like or similar parts of embodiments of the invention.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

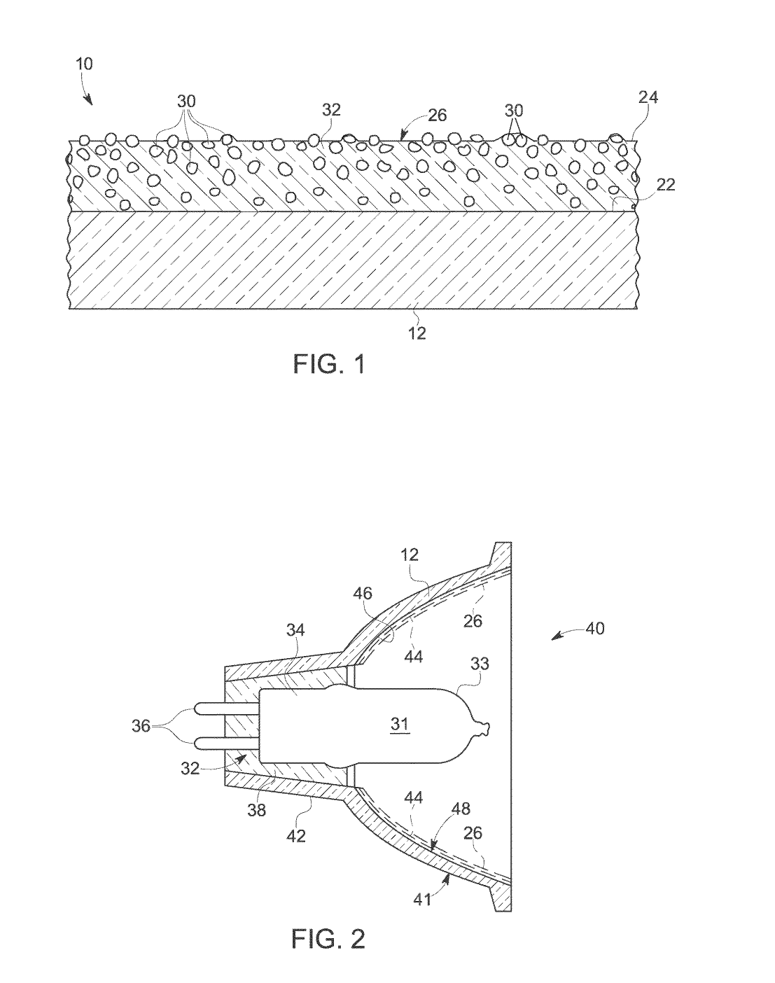

Methods are generally provided for forming a diffuse reflective coating, along with the resulting coatings formed therefrom. By adjusting the parameters of the method of formation and/or the composition of the coating, the specular reflectance of the resulting reflective coating can be controlled. FIG. 1 shows a reflective coating 26 on a surface 22 of a substrate 12, such that an outer surface 24 of the coating 26 defines the outermost surface of the resulting coated substrate 10. The substrate 12 can be constructed from any suitable material depending on the particular use of the substrate 12 and reflective coating 26. For example, the substrate 12 may contain or be formed entirely of metal, ceramic, plastic, glass, and/or quartz materials. The detail illustrated in FIG. 1 is meant to be used only for purposes of illustrating the features of the reflective coating 26 and not an exact detail of the reflective coating 26, and is not intended to be drawn to scale. As shown, the reflective coating 26 comprises a binder matrix 32 containing pigment particles 30. To produce a diffuse reflective coating adapted to scatter incident light over a range of directions, the pigment particles 30 are preferably formed of a scattering pigment material and at least some of the particles 30 protrude through or are otherwise exposed at an outermost surface 24 of the coating 26. As used herein, protrusion of particles 30 through the outermost surface 24 of the coating 26 may refer to particles 30 that protrude through or lie outside a plane of the surface 24, as is evident from FIG. 1. Furthermore, from FIG. 1 it is evident that the binder matrix 32 may partially or fully encase some particles 30 that protrude through the surface 24, including agglomerations of particles 30, such that such particles 30 are not necessarily exposed at the surface 24.

FIG. 2 shows one particularly suitable use of the reflective coating 26 on a reflector 41 that comprises the substrate 12. As shown, a lamp and reflector combination 40 comprises a lamp 31 having a vitreous envelope 33 hermetically sealed at 34 by means of a customary pinch seal or shrink seal and having exterior leads 36. The lamp 31 is cemented into a cavity of the reflector 41 by cement 38 using suitable cements for securing the lamp 31 in the reflector 41, which are generally known in the art. The lamp 31 may also contain a filament and in-leads or an arc (not shown) within the envelope 33. Alternatively, the lamp 31 may be a solid-state light source that comprises, e.g., one or more light emitting diodes (LEDs).

As shown, the reflective coating 26 is applied to an interior surface 46 of a parabolic portion 48 of the substrate 12, which may be a glass substrate, a metal substrate, etc. However, in other embodiments, the reflective coating 26 can be disposed on an outer surface 42 of the substrate 12 or reflector 41. The reflective coating 26 may be positioned directly on the inner surface 46 or on an optional primer coating 44, if desired. For example, the primer coating 44 can improve adherence and/or reflectance of the reflective coating 26. In one embodiment, the primer coating 44 can include the same materials as discussed above with respect to the reflective coating 26, which may be independently selected regardless of the composition of the reflective coating 26. In certain embodiments, the primer coating 44 can generally include the same components (i.e., a cross-linked binder, a cross-linking agent, and pigment particles), but with different relative amounts (i.e., less pigment and more binder) to improve adhesion between the substrate 12 and the reflective coating 26. Alternatively, the primer coating 44 may include materials and components that enhance the reflectance of the coated substrate 10, but are less expensive than those in the reflective coating 26, so that a lesser amount of the reflective coating 26 may be used to achieve an overall high reflectance.

During operation of the lamp and reflector combination 40, little or none of the light emitted by the lamp 31 is discernible from the outside surface 42 of the substrate 12, due to the reflective coating 26 present on the substrate 12.

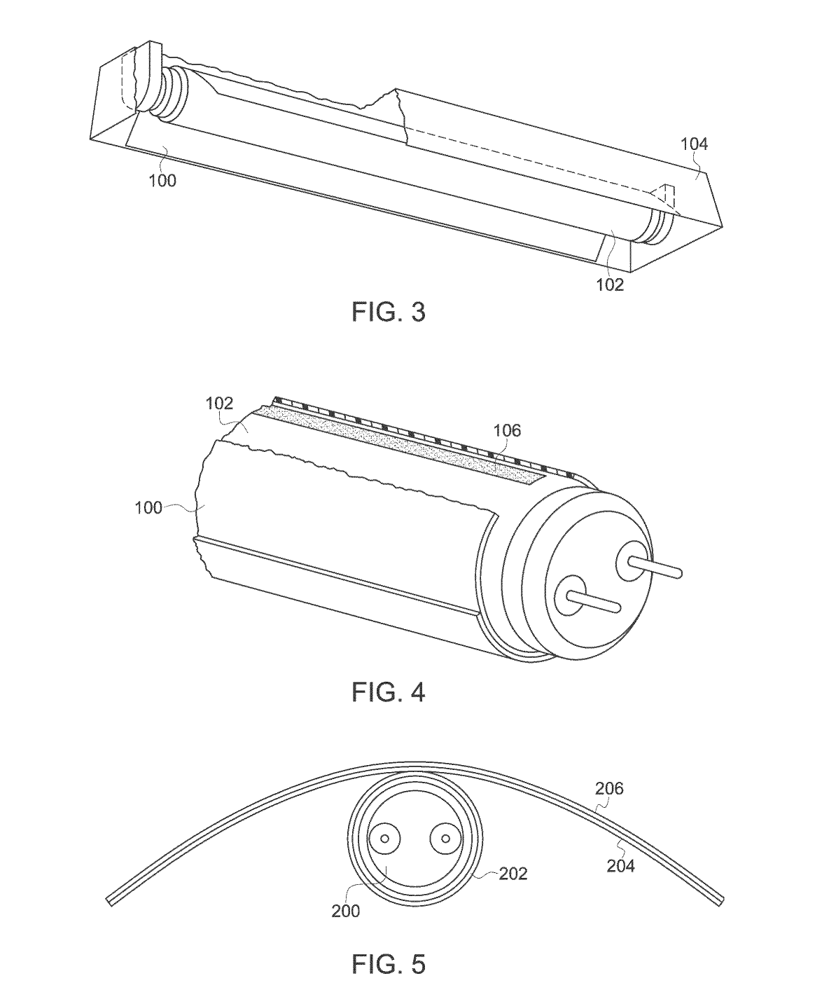

FIG. 3 shows another exemplary lighting system that can utilize the reflective coating 26 formed by the presently described methods. The exemplary lighting system of FIG. 3 includes a conformable reflector 100 positioned between a lamp 102 (e.g., a fluorescent lamp or a solid-state light source such as LEDs) and fixture housing 104 when the lamp-reflector combination is installed in a conventional fluorescent lighting fixture. As used herein, conformable is understood to mean sufficiently flexible to be wrapped about a lamp (e.g., a fluorescent lamp) and sufficiently resilient to retain a shape removed from the lamp when released. The reflector 100 can be, in one embodiment, permanently attached to the glass tube of the lamp 102 by a stripe 106 of adhesive (e.g., glue) as shown in FIG. 4. The stripe 106 may extend the full length of the reflector 100 or may be comprised of several short stripe segments aligned with the lamp 102 along the reflector 100. As shown in FIG. 4, the reflector 100 is made of a conformable material, so that the reflector 100 can be wrapped closely about the outer surface of the fluorescent lamp 102 for shipment and handling, so that no additional space is required in packaging and shipping containers for the lamp reflector combination. In certain embodiments, the conformable reflector 100 can be constructed of a substrate and reflective coating, such as the substrate 12 and reflective coating 26 shown in FIG. 1 and described above.

An alternative embodiment of a lighting system is illustrated schematically in FIG. 5. As shown, a collar 202 of flexible material, such as a plastic, surrounds a lamp 200 (e.g., a fluorescent lamp or a solid-state light source such as LEDs) and is glued into a ring, and a strip 204 of flexible material, such as a plastic, is glued to the collar 202 to which a sheet-type reflector 206 is attached by, for example, gluing. In certain embodiments, the reflector 206 can be constructed of a substrate and reflective coating (not shown), such as the substrate 12 and reflective coating 26 shown in FIG. 1 and described above. A plurality of such collars 202 can be attached to the reflector 206 along an axial length thereof with the number selected to provide the necessary support and shaping for the reflector 206. The collars 202 can be made of such size that a frictional engagement exists between the exterior surface the glass tube of the lamp 200 and the inner surface of the collars 202 with sufficient friction to allow positioning of the collars 202 and thereby the reflector 206 at any desired angular position relative to the axis of the lamp 200. Other techniques of fastening the reflector 206 to the lamp 200 are suitable, so long as the conformability of the reflector 206 is maintained.

A fluorescent lamp with a conformable reflector (for example, as depicted in FIG. 5) can be shipped as a single unit with the reflector and its support mechanism, if any, wrapped closely about the circumference of the fluorescent lamp. After installation of the fluorescent lamp in a lighting fixture, the reflector which is bound by a removable binding such as a removable adhesive or by adhesive tape or masking tape, is released to expand away from the surface of the fluorescent lamp. If the lamp and reflector combination is installed in a lighting fixture having a structure surrounding the lamps, the reflector, after release from its compact position, can be moved by the installer to conform to a desired position and shape within the fixture, using the fixture as support. In a fixture in which the reflector may expand without interference, the reflector will conform to its own natural shape which will be dictated by the resilience of the material of the reflector, the thickness of the reflector, and the mechanism of attachment to the fluorescent lamp. As stated, the reflector can generally be constructed of a substrate and a reflective coating, such as the substrate 12 and reflective coating 26 shown in FIG. 1 and described above.

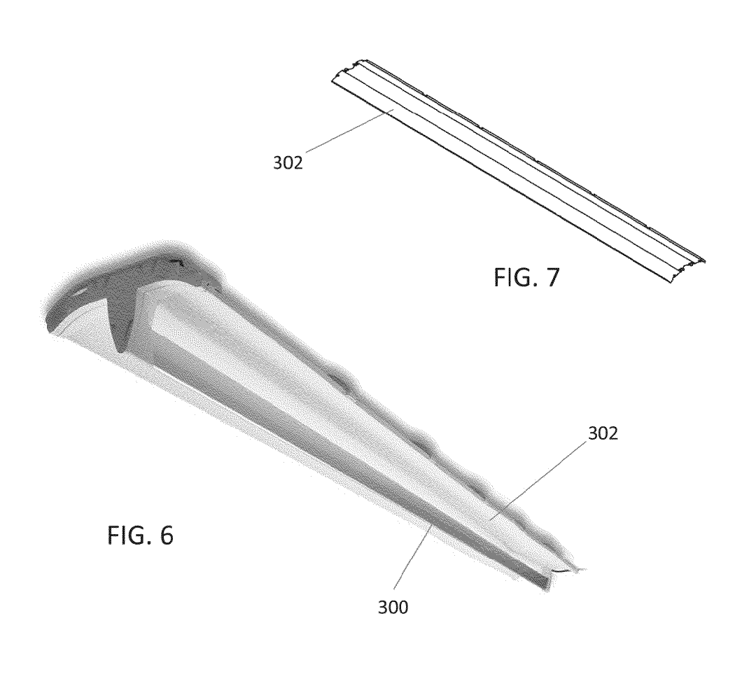

Yet another alternative embodiment of a lighting system is illustrated schematically in FIG. 6, with a reflector 302 of the lighting system shown in isolation in FIG. 7. FIG. 6 shows the reflector 302 positioned above a lamp 300 (e.g., a fluorescent lamp or a solid-state light source such as LEDs). In certain embodiments, the reflector 302 can be constructed of a substrate and reflective coating (not shown), such as the substrate 12 and reflective coating 26 shown in FIG. 1 and described above. The lighting system depicted in FIG. 6 is representative of a type of lighting fixture commercially available from GE Lighting and referred to as an indirect suspended fixture.

The reflective coating 26 can be formed from a precursor material via a curing process that involves a single curing step or multiple curing steps, and will be described in reference to at least one “hard” curing step and/or at least one “soft” curing step. As used herein, the term “soft” refers to a curing step in which the precursor material is not entirely cured such that a fully cross-linked (cured) binder matrix 32 of the reflective coating 26 is not fully formed, and the term “hard” refers to a curing step in which the precursor material is entirely or almost entirely cured and a fully cross-linked (cured) binder matrix 32 is fully or almost fully formed. For example, a single-step curing method may include applying the precursor material to the substrate 12, and then subjecting the precursor material to energy to cure the precursor material at a hard-cure energy level for a duration sufficient to hard cure the precursor material, whereby a fully cross-linked (cured) binder matrix 32 is fully or almost fully formed. Alternatively, a curing method may include applying the precursor material to the substrate 12 and then subjecting the precursor material to energy to cure the precursor material at a soft-cure energy level for a duration sufficient to soft cure the precursor material, whereby a fully cross-linked (cured) binder matrix 32 is not fully formed. If the curing method is a multistep curing method, the soft-cured precursor material can thereafter be hard cured at a hard-cure energy level for a duration sufficient to complete or nearly complete the formation of the binder matrix 32 and the reflective coating 26. The hard-cure energy level can, in particular embodiments, have a higher amount of energy than the soft-cure energy level. Additional curing steps (e.g., a third curing energy level for a third duration) may also be included in the methods, as may be desired.

In certain particular embodiments, the precursor material utilized to form the reflective coating 26 can generally include a cross-linkable (uncured) binder resin, a cross-linking agent (cross-linker), and scattering pigment particles. Each of these components can be in a dry powder form and mixed together to form a dry powder precursor material that is then deposited on the substrate 12. Alternatively, these dry powder components can be combined and deposited as a dispersion, emulsion, solution, or other mixture, with one or more carriers, solvents, etc., that generally evaporate prior to or during the curing process. In any case, the resulting reflective coating 26 generally includes the binder matrix 32 formed by reacting the cross-linkable binder resin and cross-linking agent of the precursor material, and also includes the scattering pigment particles 30 originally present in the precursor material.

The cross-linkable binder resin can generally include at least one cross-linkable polymeric binder resin that interacts with the cross-linking agent to form a three-dimensional polymeric structure (e.g., the binder matrix 32 of the reflective coating 26 of the reflectors 41, 100, 206 and/or 302 of FIGS. 2, 3, 5, 6 and 7). Generally, it is contemplated that any pair of cross-linkable binder resin and cross-linking agent that reacts to form the three-dimensional polymeric structure may be utilized. As such, the cross-linkable binder resin can include any suitable cross-linkable material prior to cross-linking, and can encompass monomers, oligomers, polymers, and (co)polymers, which may be further processed to undergo cross-linking to form the cross-linked polymeric structure. Particularly suitable cross-linkable binder resins contain at least one of the following groups: ester, urethane, epoxy, amide, isoprene, propylene, ethylene, styrene, siloxane, vinyl chloride, imide, and acrylic groups, or mixtures thereof. Particularly desirable cross-linkable binder resins include those that contain reactive carboxyl groups (e.g., acrylics and methacrylic, polyurethanes, ethylene-acrylic acid copolymers, and so forth). Other desirable cross-linkable binder resins include those that contain reactive hydroxyl groups (e.g., polyesters such as polyethylene terephthalate). Combinations of these materials can also be used to form the cross-linkable binder resin. Depending on the chemical structure, the cross-linkable binder resin can be a thermoplastic or thermoset material.

As stated, the cross-linking agent can be selected to cause cross-linking between the cross-linkable binder resin and/or cross-linking agent. The cross-linking agent can include, but is not limited to, polyfunctional aziridines (e.g., triglycidyl isocyanurate), epoxy resins, carbodiimide, oxazoline functional polymers, melamine-formaldehyde, urea formaldehyde, amine-epichlorohydrin, multi-functional isocyanates, and so forth. In certain embodiments, for instance, the cross-linking agent can be a polyisocyanate compound.

Additionally, the cross-linking agent can be selected based on the chemistry of the cross-linkable binder resin. For example, particularly suitable cross-linking agents for cross-linkable binder resins having carboxyl groups can include, but are not limited to, polyfunctional aziridines (e.g., triglycidyl isocyanurate), epoxy resins, carbodiimide, oxazoline functional polymers, and so forth. Similarly, particularly suitable cross-linking agents that can be used to cross-link binder resins having hydroxyl groups include, but are not limited to, melamine-formaldehyde, urea formaldehyde, amine-epichlorohydrin, multi-functional isocyanates, and so forth.

Combinations of cross-linking agents can be utilized, particularly when utilizing a combination of cross-linkable binder resins in the precursor material.

The scattering pigment particles 30 of the reflective coating 26 are generally reflective to light having wavelengths in a certain range. A single type of pigment can be utilized as the particles 30, or a combination of pigments can be utilized. As such, the pigment particles 30 can provide a color to the reflective coating 26 by reflecting certain wavelengths of light. For example, the pigment particles 30 can be selected for inclusion in the reflective coating 26 by its composition, particle size, and/or density for its reflectance characteristics. As a result of protruding or being exposed at the coating surface 24, as represented by some particles 30 in FIG. 1, it is believed that the particles 30 (and any agglomerates thereof) are able to contribute to a desirable light scattering effect that can be suitable for use in a diffuse reflector, in contrast to other particles 30 represented in FIG. 1 that are located beneath the surface 24 and therefore do not protrude through the surface 24.

Exemplary pigment materials that are particularly suitable for inclusion as particles 30 within the reflective coating 26 include, but are not limited to, metal oxide inorganic particles (e.g., TiO₂, Al₂O₃, Y₂O₃, ZrO₂, Ta₂O₅, Nb₂O₅, etc.), mixed metal oxide particles (MMOs), complex inorganic color pigments (CICPs), inorganic ceramic particles (e.g., BN, SiC, etc.), other inorganic pigments known for white or colored pigmentation of coatings, organic particles having a different refractive index than the cured binder resin or binder matrix 32, or any combinations thereof. In certain embodiments, these pigments can be present in the reflective coating 26 from about 1% by weight to about 90% by weight of the cured reflective coating 26 (i.e., the dry weight), such as from about 25% by weight to about 75% by weight. In particular embodiments, the pigment particles 30 may be included in the precursor material (i.e., prior to application onto the substrate and drying) in an amount of about 10% by weight to about 60% by weight when wet, such as about 30% to about 45% by weight.

One particularly suitable precursor material is a powder commercially available under the name Valspar PTW90135 from The Valspar Corporation (Minneapolis, Minn.). Valspar PTW90135W is reported to contain about 35% to about 40% by weight of titanium oxide particles in its wet state, a polyester resin powder as a cross-linkable binder resin, and triglycidyl isocyanurate (TGIC) as a cross-linking agent. Notably, this particular powder composition is typically cured at temperatures near about 180° C.

Such precursor materials can be applied to the substrate 12 as a dry powder, such as by an electrostatic coating process or another process capable of reliably depositing a dry powder to a surface. As previously noted, such a precursor material may alternatively be applied while suspended or dispersed in a liquid carrier, solvent, etc. In the event of the latter, other additives, such as processing agents, may also be combined with or present in the precursor material, including, but not limited to, dispersants, emulsifiers, viscosity modifiers (e.g., thickeners), humectants, and/or pH modifiers (e.g., buffer). Surfactants can also be present in the precursor material to help stabilize the mixture (e.g., as a dispersion, an emulsion, a solution, etc.) prior to and during application. In alternative embodiments, the precursor material can be substantially free from other materials in any significant amount such that the precursor material consists essentially of or consists entirely of the cross-linkable binder resin, the cross-linking agent, and the pigment particles 30.

As a result of deposition, the pigment particles 30 will typically be dispersed in the applied precursor material, with a significant amount of the particles 30 protruding through or otherwise being exposed at the outer surface of the applied precursor material.

As previously noted, the precursor material is not entirely cured during a soft-cure step, such that the partially cured precursor material contains uncross-linked (uncured) cross-linkable binder resin (simply referred to as the cross-linkable binder resin) and partially cross-linked (partially-cured) cross-linkable binder resin (hereinafter, partially-cured binder resin), and potentially also some portion of cross-linked (cured) cross-linkable binder resin (hereinafter, cured binder resin), whereas the precursor material is entirely or nearly entirely cured following a hard-cure step such that the cured binder resin is fully or almost fully formed within the binder matrix 32. By utilizing a multi-step curing process, with the soft-cure energy level being lower than a subsequent hard-cure energy level, the precursor material can be soft cured at conditions that inhibit migration of the precursor material and, in particular, migration of the binder resin toward the outer surface of the applied precursor material during the soft-cure step and also the subsequent hard-cure step, such that the particles 30 at the surface of the applied precursor material following deposition will predominantly protrude through or be exposed at the surface 24 of the resulting reflective coating 26, such as represented in FIG. 1. Thus, the soft-cure energy level and its duration can be, in particular embodiments, tailored or controlled to substantially prevent or at least inhibit the uncured and partially-cured portions of the cross-linkable binder resin from softening and/or flowing during curing.

Alternatively, if a one-step curing process is utilized, the precursor material is hard cured at conditions that also inhibit migration of the precursor material and, in particular, migration of the binder resin toward the outer surface of the applied precursor material during the hard-cure step, such that the particles 30 at and protruding above the surface of the applied precursor material following deposition will predominantly remain protruding through or exposed at the surface 24 of the resulting reflective coating 26, such as represented in FIG. 1. Thus, the hard-cure energy level and its duration can be, in particular embodiments, tailored or controlled to substantially prevent or at least inhibit the uncured portions of the cross-linkable binder resin from softening and/or flowing during curing.

Without wishing to be bound by any particular theory, it is believed that the energy levels and durations of the soft-cure and hard-cure conditions can be tailored to inhibit migration of the cross-linkable binder resin (and potentially that of the pigment particles 30) in the applied precursor material, providing the ability to control and set the pigment particles 30 at and near the surface 24 of the resulting reflective coating 26, while inhibiting the binder resin from flowing to the extent that the pigment particles 30 would become covered at or submersed beneath the coating surface 24. Thus, the specular reflectance of the resulting reflective coating 26 can be controlled, for example, for the purpose of producing a reflective coating 26 having a matte surface finish.

In multi-step embodiments of the invention, the amount of curing energy supplied for the soft-cure step (e.g., at a soft-cure temperature) can vary depending on the components of the precursor material. For example, soft curing at a soft-cure energy level can be achieved via heating to the soft-cure temperature, which is preferably below the softening point of the cross-linkable binder resin in the precursor material (e.g., about 5° C. or more below the softening point of the cross-linkable binder resin). In certain embodiments, the soft-cure step can be performed at a soft-cure temperature that is about 100° C. or less (e.g., about 90° C. or less). In particular embodiments, soft curing can be performed at a soft-cure temperature that is about 75° C. to about 100° C., such as about 80° C. to about 95° C.

The soft-cure step can be performed at the soft-cure energy level for any suitable duration to partially but not fully cure the cross-linkable binder resin, and sufficient to inhibit or substantially prevent migration of the cross-linkable binder resin (and potentially the pigment particles 30) in the deposited precursor material during the soft-cure step and thereafter during the hard-cure step. For example, the soft-cure step can be performed at a soft-cure energy level (e.g., soft-cure temperature) for a suitable duration. In one embodiment, the soft-cure duration can be up to about 2 hours, for example, about 1 minute to about 1.5 hours.

After completing a soft-cure step, the precursor material predominantly contains uncured (uncross-linked) cross-linkable binder resin and the partially-cured (partially cross-linked) binder resin, and potentially also some portion of cured (cross-linked) binder resin. The uncured cross-linkable binder resin and partially-cured binder resin can then be hard cured at a hard-cure energy level for a hard-cure duration to fully form the fully or at least substantially cured (cross-linked) binder matrix 32 of the reflective coating 26. In general, a hard-cure step involves applying more energy to the precursor material than applied during any preceding soft-cure step to ensure that a reflective coating 26 is formed with sufficient cross-linking (particularly between the cross-linkable binder resin and/or the cross-linking agent). A hard-cure energy level is generally a higher energy level than any preceding soft-cure energy level. When thermally cured via heating (i.e., soft cured at a soft-cure temperature and then hard cured at a hard-cure temperature), the hard-cure temperature is higher than the soft-cure temperature, yet below the glass transition temperature of the cured binder resin that formed during the hard-cure step, as well as any portion of cured binder resin that formed during the soft-cure step. In one embodiment, the hard-cure temperature can be at least about 1° C. greater than the soft-cure temperature, such as about 10° C. or more. In certain embodiments, the hard-cure temperature can be about 25° C. or higher. For example, the hard-cure temperature can be about 100° C. to about 150° C., such as about 105° C. to about 125° C.

The curing temperatures of preferred cross-linkable binder resins are close to and preferably lower than the softening temperatures of the binder resins when uncured, partially cured, and fully cured, such that the hard-cure energy (temperature here) can be sufficiently high to activate the active groups in the cross-linkable binder resin and cross-linking agent for reaction, but not so high as to soften and flow the uncured and partially-cured precursor material during the process of forming the binder matrix 32. After a fixed period at the hard-cure energy, uncured cross-linkable binder resin becomes partly cross-linked (partially cured), and further time at the hard-cure energy serves to further cross-link (cure) the binder resin, but not enough to soften any uncured cross-linkable binder resin and any partially-cured binder resin, so that at least some of the particles 30 originally at the surface of the applied precursor material protrude through the surface 24 or remain exposed by the binder matrix 32 at the surface 24 of the resulting reflective coating 26, as depicted in FIG. 1. Optionally, by adjusting the hard-cure energy to be above the energy needed to soften the uncured and partially-cured binder resin, some degree of glossiness can be achieved for the coating 26 through controlled promotion of the migration of the cross-linkable binder resin in the precursor material so that some of the particles 30 originally at the surface of the applied precursor material may be covered by the binder matrix 32 at the surface 24 of the resulting reflective coating 26, as also depicted in FIG. 1.

The hard-cure step can be performed at the hard-cure energy level for any suitable duration, such as sufficient to cross-link the binder resin to form the binder matrix 32 of the reflective coating 26. For example, the hard-cure step can be performed at a hard-cure energy level (e.g., a hard-cure temperature) for a duration that is about 1 minute or longer. In one embodiment, the hard-cure duration can be about 1 minute to about 2 hours, such as about 5 minutes to about 1.5 hours.

In embodiments in which the reflective coating 26 is formed from a precursor material via a curing process that has a single curing step, a longer hard-cure step may be performed at a hard-cure energy level (e.g., temperature) as described above, and for a period of time (duration) that is sufficient to provide the total amount of curing energy required for the particular binder resin. As with the hard-cure step of one of the aforementioned multi-step curing processes, the hard-cure energy (temperature) of a hard-cure step of a single-step curing process should be sufficiently high to activate the active groups in the cross-linkable binder resin and cross-linking agent for reaction, but not so high as to soften and flow the uncured cross-linkable binder resin and the cured and/or partially-cured binder resin that forms during the hard-cure step, so that at least some of the particles 30 originally at the surface of the applied precursor material protrude through or remain exposed by the binder matrix 32 at the surface 24 of the resulting reflective coating 26, as depicted in FIG. 1. For example, the single curing step can be performed at 100° C. or less (e.g., about 90° C. or less), without additional curing at higher temperatures, for a curing duration that is sufficient to inhibit or substantially prevent migration of the cross-linkable binder resin in the precursor material and yet sufficiently cross-link the binder to a desired level. For example, the hard-cure step can be performed at a hard-cure energy level (e.g., a hard-cure temperature) for a hard-cure duration that is about 10 minutes or longer. In one embodiment, the hard-cure duration can be about 10 minutes to about 1 hour. As before, the hard-cure energy can optionally be adjusted to be above the energy needed to soften the uncured and partially-cured binder resin, such that some degree of glossiness can be achieved for the coating 26 through controlled promotion of the migration of the cross-linkable binder resin in the precursor material, with the result that some of the particles 30 originally at the surface of the applied precursor material may become covered by the binder matrix 32 at the surface 24 of the resulting reflective coating 26, as depicted in FIG. 1.

No matter the particular method of curing, the reflective coating 26 can be formed to any desired thickness, but is particularly suitable for films formed on a micrometer (μm) scale. For example, the reflective coating 26 can have a thickness that is about 5 μm to about 500 μm, such as about 100 μm to about 250 μm. This thickness can be achieved via a single layer deposition or multiple layers of deposition.

Through these methods, the type and relative amounts of diffuse reflectance (e.g., gloss vs. matte diffuse reflection) can be controlled in the resulting reflective coating 26. In certain embodiments, specular gloss can be about 4 gloss units (GU) or less at a 60° incident angle, as measured by the ASTM test method D523-08, titled “Standard Test Method for Specular Gloss,” as published in June 2008. For example, the reflective coating 26 can reflect at least about 90% of light in the visible spectrum, with a specular gloss down to about 1 GU or less at a 60° incident angle. As used herein, a matte finish refers to a specular gloss of less than 4 GU.

In one embodiment, the reflective coating 26 can reflect at least about 90% of light in the visible spectrum, such as at least about 97% of light in the visible spectrum or at least about 99% of light in the visible spectrum. In another embodiment, the reflective coating 26 can reflect at least about 90% of light in the infrared spectrum, such as at least about 97% of light in the infrared spectrum or at least about 99% of light in the infrared spectrum.

The reflective coating 26 formed according to the methods described herein can be utilized in a wide variety of applications. In certain embodiments, the reflective coating 26 can be utilized in a lighting device, including but not limited to the systems depicted in FIGS. 2 to 7. In such embodiments, a matte finish can be achieved with their respective reflectors, for example, to enable a Lambertian distribution with LED light sources without creating LED dot images on the reflector surface. In another particular application it can be utilized as a diffuse reflector of solar radiation such that the reflected glare is very low, while the total reflectance is very high. In another particular application it can be utilized as the reflective coating inside an integrating sphere which is an optical instrument for measuring the total light flux emitted from a light source, typically requiring the combination of very high reflectance and very low gloss over the visible spectrum, or in other optical instrumentation requiring those optical properties of the reflector. In such applications in optical instrumentation, the reflective coating 26 may be considered to be more rugged, and less expensive than “integrating sphere paints” that are commonly used.

The reflective coating 26 can be included on any substrate 12, and may be utilized in any lighting device where a reflective coating or paint is present (e.g. fluorescent luminaires, LED/OLED luminaires, reflectors inside of sealed lamps, cove enclosures surrounding light sources, architectural features that serve to reflect light, desk lamps, and other fixtures that distribute the light from a light source.

A desired thickness for the coating 26 can be achieved via a single layer deposition or multiple layers of deposition. For example, in one embodiment, a relatively thin base layer can be formed first (e.g., to a thickness of about 1 μm to about 50 μm), followed by electrostatic deposition of the remainder of the thickness, to take advantage of faster deposition rates.

As with prior embodiments, the cross-linkable binder resin of the powder interacts with the cross-linking agent to form a three-dimensional polymeric structure (e.g., the binder matrix 32 of the reflective coating 26 of the reflectors 41, 100, 206 and/or 302 of FIGS. 2, 3, 5, 6 and 7). Due to the near simultaneous deposition, melting, and crosslinking, of the binder resin, the positioning of the pigment particles 30 can be fixed during deposition to inhibit migration of the pigment particles 30 and/or the cross-linkable binder resin in the precursor material. This result allows for the user to control and set the pigment particles 30 near the surface of the resulting reflective coating 26, while inhibiting the resin to substantially cover the pigment particles 30. Thus, the specular reflectance of the resulting reflective coating 26 can be controlled.

In the present disclosure, when a layer is being described as “on” or “over” another layer or substrate, it is to be understood that the layers can either be directly contacting each other or have another layer or feature between the layers, unless expressly stated to the contrary. Thus, these terms are simply describing the relative position of the layers to each other and do not necessarily mean “on top of” since the relative position above or below depends upon the orientation of the device to the viewer.

Chemical elements are discussed in the present disclosure using their common chemical abbreviation, such as commonly found on a periodic table of elements. For example, titanium is represented by its common chemical abbreviation Ti; aluminum is represented by its common chemical abbreviation Al; and so forth.

It is to be understood that the ranges and limits mentioned herein include all sub-ranges located within the prescribed limits, inclusive of the limits themselves unless otherwise stated. For instance, a range from 100 to 200 also includes all possible sub-ranges, examples of which are from 100 to 150, 170 to 190, 153 to 162, 145.3 to 149.6, and 187 to 200. Further, a limit of up to 7 also includes a limit of up to 5, up to 3, and up to 4.5, as well as all sub-ranges within the limit, such as from about 0 to 5, which includes 0 and includes 5 and from 5.2 to 7, which includes 5.2 and includes 7.

### Examples

Reflective coatings were prepared utilizing the same precursor composition, deposited at substantially the same thickness (between about 25 μm to about 250 μm) onto aluminum and steel substrates under different curing conditions. The precursor composition was the aforementioned Valspar PTW90135, containing a polyester powder as the cross-linkable binder resin that, when cured, forms a thermoset binder.

| | Total R at different | | | | | | Specular R at different | |
|---|---|---|---|---|---|---|---|---|
| | incident angles | | | | | | incident angles | |
| | Angle = | | | | | | | |
| Process conditions | 0° | 15° | 30° | 45° | 60° | 75° | 60° | 75° |

Examples of Two-Step Curing

| | | | | | | | | |
|---|---|---|---|---|---|---|---|---|
| Soft cure (90° C. for 1 hr.) + | 96.6 | 97.4 | 98.1 | 98.5 | 98.7 | 96 | 0 | 0 |
| hard cure (100° C. for 20 min) | | | | | | | | |
| Soft cure (90° C. for 1 hr.) + | 95.6 | 96.4 | 96.8 | 96.7 | 96.8 | 92.9 | 0 | 0 |
| hard cure (120° C. for 20 min) | | | | | | | | |
| Soft cure (90° C. for 1 hr.) + | 94.9 | 95.7 | 96.2 | 96.6 | 96.6 | 92.4 | 0 | 0.3 |
| hard cure (110° C. for 20 min) | | | | | | | | |
| Soft cure (90° C. for 1 hr.) + | 96.4 | 96.9 | 97.5 | 97.5 | 96.4 | 91.3 | 0.5 | 0.8 |
| hard cure (135° C. for 20 min) | | | | | | | | |
| Soft cure (90° C. for 1 hr.) + | 94.7 | 95.2 | 95.5 | 95.2 | 94.3 | 88.6 | 5.3 | 9.3 |
| hard cure (150° C. for 20 min) | | | | | | | | |

Examples of Single-Step Curing

| | | | | | | | | |
|---|---|---|---|---|---|---|---|---|
| Hard cure (100° C. for 20 min) | 88.8 | 89.1 | 89.3 | 88.9 | 87.4 | 80.7 | 4.4 | 9.3 |
| Hard cure (110° C. for 20 min) | 91 | 93 | 93.3 | 93.2 | 92.5 | 86.5 | 6.3 | 11.8 |
| Hard cure (120° C. for 20 min) | 91.3 | 93.7 | 94 | 93.7 | 92.7 | 81.8 | 8.9 | 18.9 |
| Hard cure (135° C. for 20 min) | 92.2 | 93.4 | 93.6 | 93.7 | 92.7 | 85 | 7.8 | 17.1 |
| Hard cure (150° C. for 20 min) | 93.3 | 94.1 | 94.4 | 94.4 | 93.6 | 89.6 | 6.2 | 11.2 |
| Hard cure (160° C. for 20 min) | 94.6 | 95.6 | 96 | 96 | 95.5 | 89.3 | 6.1 | 11.9 |
| Hard cure (180° C. for 20 min) | 93.6 | 95 | 95.3 | 95 | 93.8 | 86 | 7.3 | 13.5 |

As shown above, the specular reflectance increases with a temperature increase of the hard-cure conditions. In particular, if a multi-step curing process was used, a suitable matte finish was obtained if both soft-cure and hard-cure temperatures were below 150° C., and if a single-step curing process was used, a suitable matte finish was obtained if the hard-cure temperature was about 100° C. Not wishing to be bound by any particular theory, it is believed that the binder resin softened and flowed above the pigment particles (TiO₂) at the higher temperatures for hard-cure, increasing the relative amount of cross-linked thermoset resin at the coating surface, which led to a glossier coating surface. Additionally, without the soft-cure step, the uncured and partially cross-linked resins were more likely to soften and flow over the pigment particles, again leading to a glossier coating surface, as evident from the examples that underwent single-step cures at temperatures of 100° C. or more. It is expected that similar results would be obtained on many other metallic substrates by suitable choice of the coating process parameters.

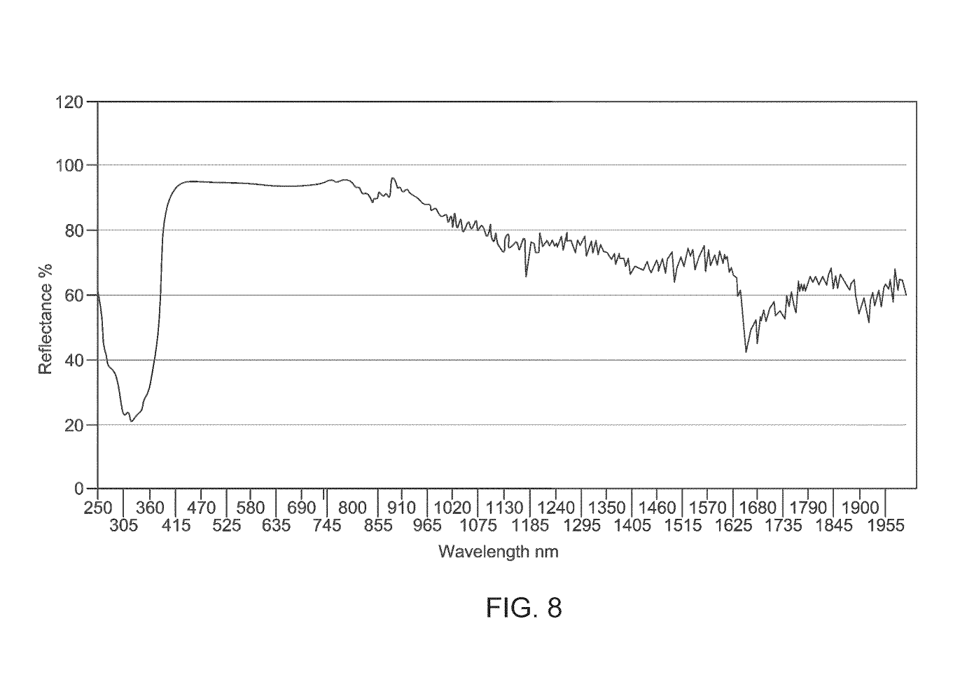

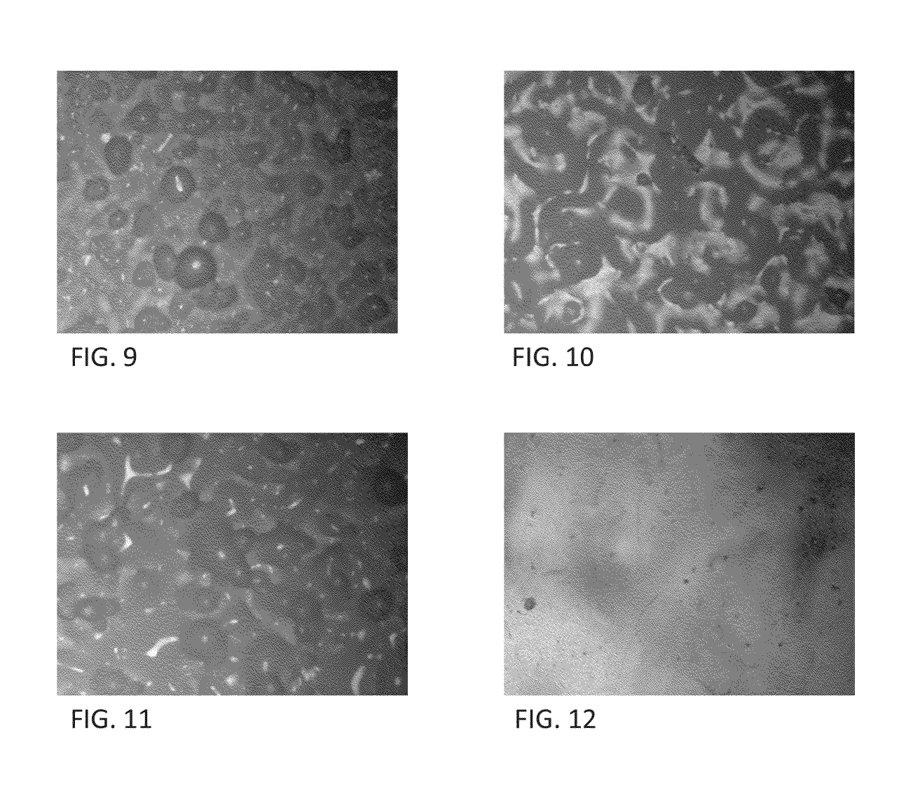

FIG. 8 shows the reflectance spectra of a Reflective coating formed from the Valspar PTW90135 polyester resin hard cured at 105° C. for about twenty minutes. FIGS. 9, 10, 11 and 12 are images showing reflective coatings formed from the Valspar PTW90135 that underwent, respectively, soft-cure at 90° C. for about one hour and hard-cure at 100° C. for about twenty minutes, hard-cure only at 100° C. for about twenty minutes, soft-cure at 90° C. for about one hour and hard-cure at 110° C. for about twenty minutes, and hard-cure only at 110° C. for about twenty minutes. The specimens in FIGS. 9, 10 and 11 show that sufficient scattering particles remain present at (protrude) and in some cases are exposed at the surfaces of their respective coatings to achieve an acceptable matte finish for many applications, whereas in FIG. 12 the particles have become entirely covered by the binder during curing, resulting in a glossy coating surface. These coatings also indicate that the soft-cures stabilized the polyester resin and stopped or delayed its migration over particles exposed at the coating surfaces, as compared with coatings cured without a soft-cure step, even if the same hard-cure temperature was used.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other and examples are intended to be within the scope of the claims if they include structural elements that do not differ from the literal language of the claims, or if they include equivalent structural elements with insubstantial differences from the literal languages of the claims.

What is claimed is:

1. A method for forming a reflective coating on a substrate, the method comprising:
applying a precursor material to a surface of the substrate, the precursor material comprising a cross-linkable binder resin, a cross-linking agent, and scattering pigment particles; and
curing the applied precursor material to form the reflective coating by cross-linking the cross-linkable binder resin to form a cured binder resin and optionally a partially-cured binder resin, the curing comprising at least one of a soft-cure step and a hard-cure step, the curing sufficiently inhibiting softening and migration of the cross-linkable binder resin, the cured binder resin, and any of the optional partially-cured binder resin so that a sufficient amount of the pigment particles protrude through or remain exposed at an outer surface of the reflective coating to achieve a matte finish at the outer surface.

2. The method as in claim 1, wherein the curing comprises the hard-cure step which is performed at a hard-cure energy level for a hard-cure duration sufficient to cross-link the cross-linkable binder resin and form the cured binder resin, and the curing comprises the soft-cure step which is performed before the hard-cure step and at a soft-cure energy level for a soft-cure duration sufficient to at least partially cross-link the cross-linkable binder resin and form the partially-cured binder resin.

3. The method as in claim 2, wherein the hard-cure energy level is great than the soft-cure energy level.

4. The method as in claim 2, wherein the hard-cure energy level is achieved via heating to a hard-cure temperature that is below a softening point of the cured binder resin in the reflective coating.

5. The method as in claim 1, further comprising controlling surface glossiness at the outer surface of the reflective coating by controlling the migration of the cross-linkable binder resin, the cured binder resin, and any of the optional partially-cured binder resin and coverage thereby of pigment particles that were at or near the outer surface of the applied precursor material.

6. The method as claim 1, wherein the matte finish at the outer surface of the reflective has a specular gloss of about 4 gloss units or less at a 60 degree incident angle.

7. The method as in claim 1, wherein the cross-linkable binder resin comprises at least one of monomers, oligomers, polymers, and copolymers, and contains at least one group chosen from ester, urethane, epoxy, amide, isoprene, propylene, ethylene, styrene, siloxane, vinyl chloride, imide, and acrylic groups.

8. The method as in claim 1, wherein the cross-linking agent comprises polyfunctional aziridines, epoxy resins, carbodiimide, oxazoline functional polymers, melamine-formaldehyde, urea formaldehyde, amine-epichlorohydrin, multi-functional isocyanates, or combinations thereof.

9. The method as in claim 1, wherein the cross-linkable binder resin interacts with the cross-linking agent to cross-link the cross-linkable binder resin and form a three-dimensional cross-linked polymeric structure.

10. The method as in claim 1, wherein the cross-linkable binder resin comprises a polymeric powder, and during the curing step the polymeric powder does not completely cover pigment particles that were at or near the outer surface of the applied precursor material.

11. The method as in claim 1, wherein the pigment particles comprise inorganic particles.

12. The method as in claim 1, wherein the pigment particles comprise organic particles having a different refractive index than the cured binder resin.

13. The method as in claim 1, wherein the substrate is a component of a lighting apparatus.

14. The method as in claim 1, wherein the reflective coating reflects at least 90% of light in the visible spectrum and has a matte finish having a specular gloss of about 4 gloss units or less at a 60 degree incident angle.

15. A lighting apparatus comprising:
a light source;
the reflective coating formed on the substrate according to the method of claim 1, the reflective coating being positioned to reflect light emitted by the light source; and
optionally, a primer coating between the reflective coating and the substrate.

16. The lighting apparatus as in claim 15, wherein the reflective coating is reflective in the visible spectrum of light.

17. The lighting apparatus as in claim 15, wherein the reflective coating is reflective in the infrared spectrum of light.

18. A method for forming a diffuse reflective coating on a surface of a substrate, the method comprising:
applying a precursor material to the surface of the substrate, the precursor material comprising a cross-linkable binder resin, a cross-linking agent, and scattering pigment particles, at least some of the pigment particles being at or near an outer surface of the applied precursor material;
soft-curing the applied precursor material at a soft-cure energy level to at least partially cross-link the cross-linkable binder resin and form a cured binder resin and a partially-cured binder resin, the soft-curing sufficiently inhibiting softening and migration of the cross-linkable binder resin, the cured binder resin, and the partially-cured binder resin so that an amount of the pigment particles that were at or near the outer surface of the applied precursor material protrude through or remain exposed; and
optionally hard-curing the applied precursor material at a hard-cure energy level to form the reflective coating by further cross-linking the cross-linkable binder resin and the partially-cured binder resin, stabilize the cured binder resin, and form additional cured binder resin, the hard-curing sufficiently inhibiting softening and migration of the partially-cured binder resin, the cured binder resin, and the additional cured binder resin so that a sufficient amount of the pigment particles that were at or near the outer surface of the applied precursor material protrude through or remain exposed at an outer surface of the reflective coating to achieve a matte finish at the outer surface that has a specular gloss of about 4 gloss units or less at a 60 degree incident angle.

19. The method as in claim 18, wherein the soft-cure energy level is achieved via heating to a soft-cure temperature that is below a softening point of the cured binder resin, and the hard-cure energy level is achieved via heating to a hard-cure temperature that is higher than the soft-cure temperature but below the softening point of the cured binder.
